(19) United States
(12) Patent Application Publication
(10) Pub. No.: US 2002/0084620 A1
(43) Pub. Date: Jul. 4, 2002

(54) Mini bicycle

(76) Inventors: Chih-Wang Yu, Taipei (TW); Chih-Yung Yu, Taipei (TW)

Correspondence Address: Chih-Wang Yu, 235 Chung-Ho, Box 8-24, Taipei, TW

(21) Appl. No.: 09/938,049

(22) Filed: Aug. 24, 2001

(30) Foreign Application Priority Data
Dec. 21, 2000 (TW) 089222470

(51) Int. Cl. B62K 15/00; B62M 1/02

(52) U.S. Cl. 280/283; 280/259

(57) ABSTRACT

A mini bicycle in which the chain stays are respectively pivoted to a bracket at the seat tube to support the pedal-driven chain transmission mechanism. The seat tube extends across a rear part of the upper tube and connected to the rear end of the lower tube to hold the saddle stem, enabling the saddle stem to be vertically adjustably locked at the desired elevation. The springing is coupled between downwardly extended rear lugs of the upper tube and the chain stays, and the handlebar assembly is vertically adjustably coupled to the head tube and locked at the desired elevation.

### BACKGROUND OF THE INVENTION

1. Field of the Invention

The present invention relates to a bicycle, and more particularly, to a mini bicycle, which is easy and inexpensive to be manufactured and enables the user to adjust the elevation of the saddle and the handlebar.

2. Description of the Related Art

FIG. 1 shows a mini bicycle according to the prior art. This structure of mini bicycle comprises a bicycle frame formed of a head tube, a seat tube, a cross tube connected between the head tube and the seat tube, a handlebar coupled to the head tube and locked at a predetermined elevation, a bottom bracket fixedly provided at the bottom end of the seat tube adapted to hold the bearing axle of a pedal-driven chain transmission mechanism, two chain stays respectively welded to the bottom bracket, and a springing coupled between a lug at the seat tube and the chain stays. This structure of mini bicycle is not tolerablein use. Because the welding portions between the bottom bracket and the chain stays receive vibrations directly during running of the mini bicycle, they tend to be damaged upon an impact applied thereon. Another drawback aboutthe structure of mini bicycle is that the elevation of the handlebar is not adjustable. Furthermore, because the seat tube extends from the bottom bracket, its length is limited, and the elevational adjustment range of the saddle stem is limited too.

### SUMMARY OF THE INVENTION

The invention has been accomplished to provide a mini bicycle, which eliminates aforesaid drawbacks.

It is one object of the present invention to provide a mini bicycle, which is easy and inexpensive to be manufactured.

It is another object of the present invention to provide a mini bicycle, which enables the user to adjust the elevation of the saddle and the handlebar.

According to one aspect of the present invention, the bicycle frame is comprised of a upper tube, a head tube, a lower tube, and a seat tube, and chain stays which are respectively pivoted to a bracket at the seat tube to hold a barrel that supports bearing axle of the pedal-driven chain transmission mechanism.

According to another aspect of the present invention, a spring is coupled between downwardly extended rear lugs of the upper tube and the chain stays.

According to another aspect of the present invention, the seat tube extends across a rear part of the upper tube and connected to the rear end of the lower tube to hold the saddle stem for enabling the saddle stem to be vertically adjustably locked at a desired elevation, and the handlebar assembly is vertically adjustably coupled to the head tube and locked at the desired elevation.

### BRIEF DESCRIPTION OF THE DRAWINGS

FIG. 1 is an elevational view of a mini bicycle according to the prior art.

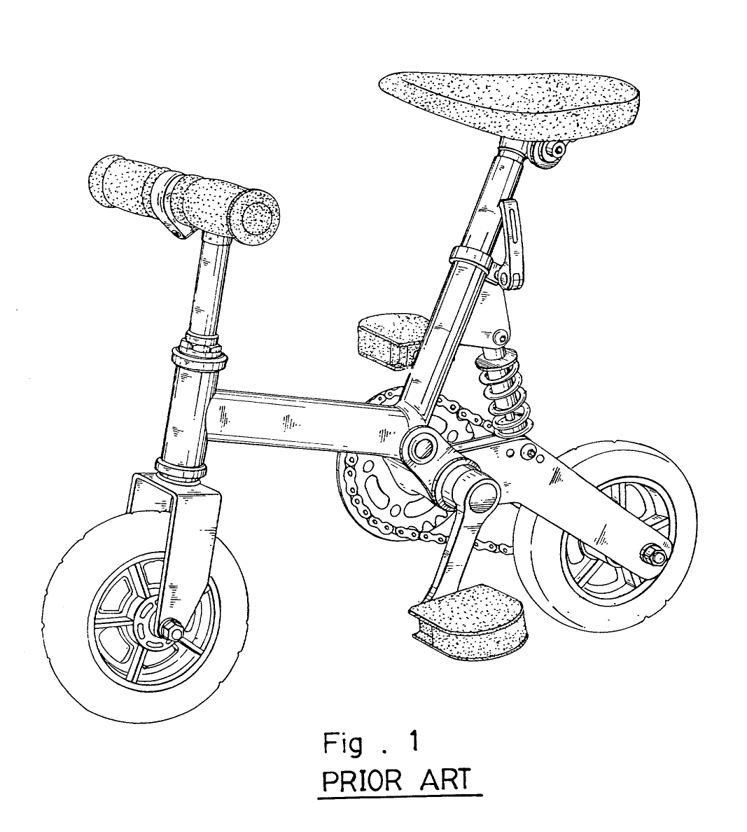

FIG. 2 is an elevational view of a mini bicycle according to the present invention.

FIG. 3 is an exploded view of a part of the mini bicycle according to the present invention.

FIG. 4 is a side plain view of the mini bicycle according to the present invention.

FIG. 5 is a schematic viewshowing the handlebar and the saddle adjusted vertically.

### DETAILED DESCRIPTION OF THE PREFERRED EMBODIMENT

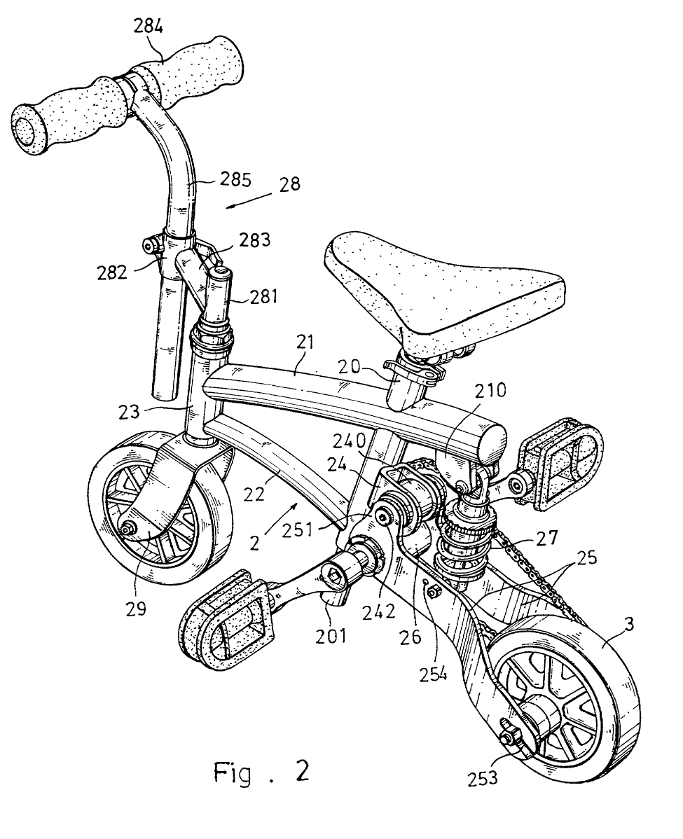

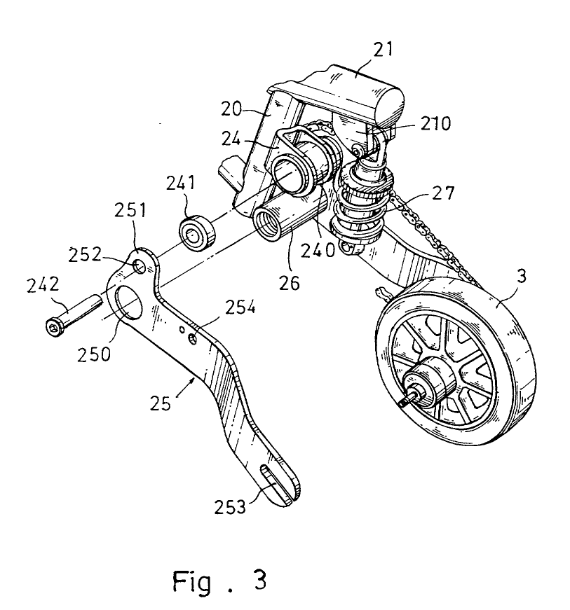

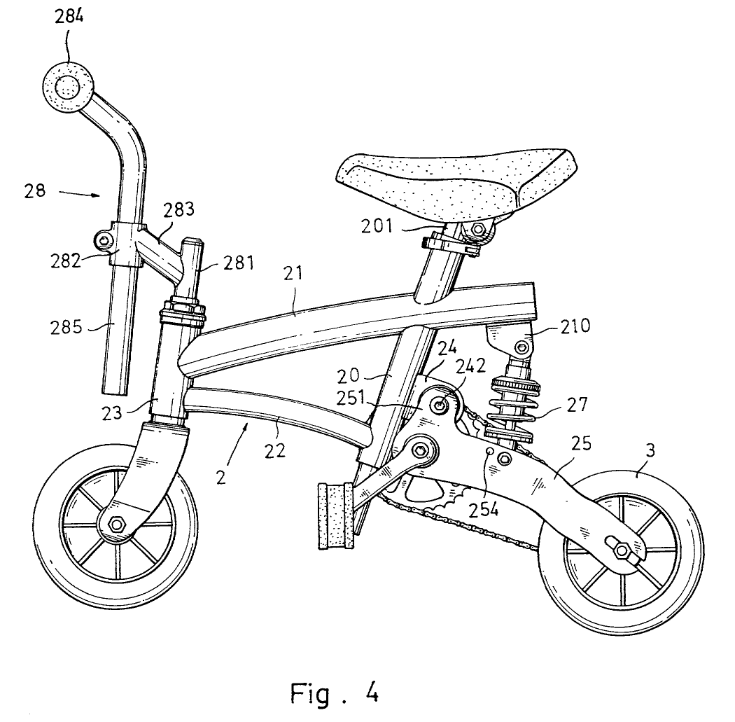

Referring to FIGS. 2 to 4, a mini bicycle of the present invention is shown. The mini bicycle comprises a bicycle frame 2 formed of a upper tube 21, a lower tube 22, a head tube 23, and a seat tube 20. A bracket 24 is fixedly provided at the seat tube 20 at a backside. The upper tube 21 has two downward lugs 210 at the rear end. Two chain stays 25 are pivoted to the bracket 24. A spring 27 is coupled between the lugs 210 and the chain stays 25. The upper tube 21 and the lower tube 22 have respective front ends respectively firmly secured to the head tube 23. The seat tube 20 extends across a rear part of the upper tube 21 and connected to the rear end of the lower tube 22. A saddle stem 201 is inserted into the seat tube 20 and locked (by a quick-releasing lock of the known art) at the desired elevation to hold a saddle on which the rider of the mini bicycle sits. The bracket 24 holds a transversely extended barrel 240. Two axle bearings 241 are mounted in two ends of the barrel 240 to support a pivot pin 242. The chain stays 25 are respectively pivoted to the pivot pin 242 and disposed at two ends of the barrel 240, each comprising a front mounting hole 250 disposed at one end, an end coupling notch 253 disposed at the other end and coupled to a rear wheel 3, a front lug 251 disposed above the front mounting hole 250, an axle hole 252 provided at the front lug 251 and coupled to the pivot pin 242, and one through hole 254 spaced between the front mounting hole 250 and the end coupling notch 253 for mounting the spring 27. A barrel 26 is fastened to the front mounting hole 250 of each of the chain stays 25 for mounting a pedal-driven chain transmission mechanism adapted to propel the rear wheel 3. A handlebar assembly 28 is installed in the head tube 23. The handlebar assembly 28 comprises a handlebar stem 281 mounted in the head tube 23 and connected to a front fork 29, a connecting bar 283 obliquely extended from the handlebar stem 281, a quick releasing lock-controlled axle clamp 282 provided at one end of the connecting bar 283 remote from the handlebar stem 281, and a handlebar 285 fastened to the quick release lock-controlled axle clamp 282. The handlebar 285 has two handgrips 284.

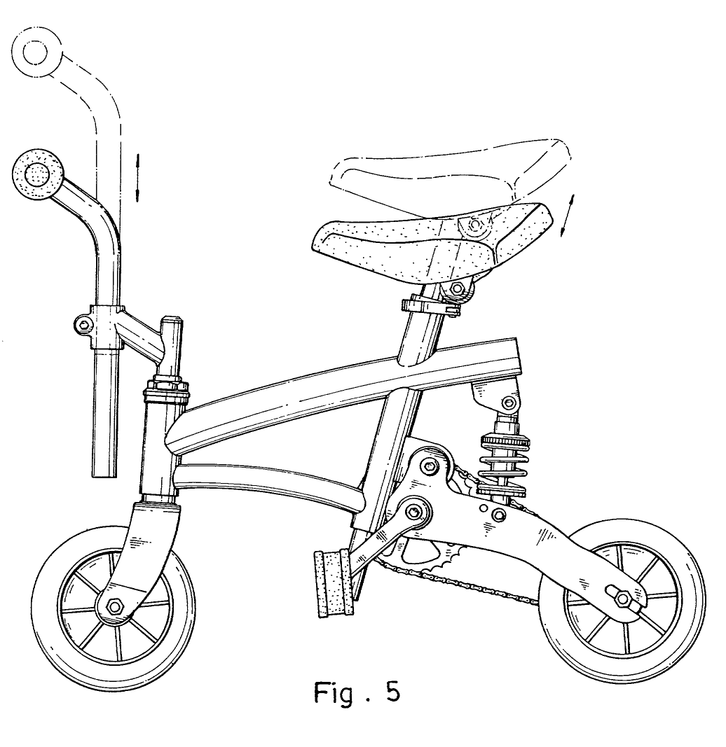

Referring to FIG. 5, the handlebar assembly 28 and the saddle stem 201 can be moved vertically in the head tube 23 and the seat tube 20, and then respectively locked at a desired elevation.

As indicated above, the assembly process of the mini bicycle is easy because no welding procedure is necessary for connecting the chain stays to the bracket. Since the seat tube extends from the rear end of the lower tube to run across a part of the upper tube, the seat tube has a certain length, enabling the saddle stem to be adjusted vertically within a longer range. Furthermore, because the handlebar stem comprises a quick releasing lock-controlled axle clamp adapted to hold the handlebar, the handlebar can be adjusted vertically to different heights.

It is appreciated that above descriptions are only utilized to illustrated the present invention and are not intended to confine scope and spirit of the invention disclosed in the appended claims.

What is claimed is:

1. A mini bicycle comprising a bicycle frame formed of a head tube, a upper tube, a seat tube, and a lower tube, a handlebar assembly coupled to said head tube for holding a front fork and a front wheel at said front fork, a saddle stem mounted in said seat tube for holding a saddle, a rear wheel, two chain stays coupled between said seat tube and said rear wheel, a spring coupled between said upper tube and said chain stays, and a pedal-driven chain transmission mechanism adapted to rotate said rear wheel, characterized in that:
said seat tube extends across a rear part of said head tube, having a bottom end fixedly connected to a rear end of said lower tube and a bracket fixedly provided at a rear side thereof near the bottom end; said chain stays each comprise a front end, a rear end, a front mounting hole disposed in said front end and fastened to one end of a barrel, which supports a bearing axle of said pedal-driven chain transmission mechanism, an end coupling notch disposed in said rear end and coupled to said rear wheel, and a front lug upwardly extended from said front end and pivoted to one side of said bracket by pivot means; said handlebar assembly comprises a handlebar stem mounted in said head tube and connected to said front fork, a fixed connecting bar obliquely extended from said handlebar stem, a handlebar, and a quick release lock-controlled axle clamp provided at one end of said connecting bar remote from said handlebar stem and adapted to lock said handlebar at the desired elevation.

2. The mini bicycle as claimed in claim 1 wherein said chain stays each further comprise at lest one through hole spaced between the respective front mounting hole and the respective end coupling notch adapted to hold one end of said springing.
